(19) United States
(12) Patent Application Publication
(10) Pub. No.: US 2026/0288900 A1
(43) Pub. Date: Sep. 24, 2026

(54) WEIGHT-STATIONARY MATRIX MULTIPLY ACCELERATION WITH A PREFILLED MEMORY HIERARCHY

(71) Applicant: Akeana, Inc., Santa Clara, CA (US)

(72) Inventors: Yogesh Shamkant Thombre, Pleasanton, CA (US); David Cureton Baker, Austin, TX (US); David St Clair Scott, Portland, OR (US)

(73) Assignee: Akeana, Inc., Santa Clara, CA (US)

(21) Appl. No.: 19/672,941

(22) Filed: May 11, 2026

Related U.S. Application Data
(63) Continuation-in-part of application No. 19/424,486, filed on Dec. 18, 2025.
(63) Continuation-in-part of application No. 19/289,177, filed on Aug. 4, 2025.
(60) Provisional application No. 63/679,192, filed on Aug. 5, 2024.
(60) Provisional application No. 63/679,685, filed on Aug. 6, 2024.
(60) Provisional application No. 63/687,795, filed on Aug. 28, 2024.
(60) Provisional application No. 63/690,822, filed on Sep. 5, 2024.
(60) Provisional application No. 63/691,351, filed on Sep. 6, 2024.
(60) Provisional application No. 63/699,245, filed on Sep. 26, 2024.
(60) Provisional application No. 63/702,192, filed on Oct. 2, 2024.
(60) Provisional application No. 63/714,529, filed on Oct. 31, 2024.
(60) Provisional application No. 63/719,841, filed on Nov. 13, 2024.
(60) Provisional application No. 63/730,997, filed on Dec. 12, 2024.
(60) Provisional application No. 63/735,937, filed on Dec. 19, 2024.
(60) Provisional application No. 63/735,937, filed on Dec. 19, 2024.
(60) Provisional application No. 63/745,432, filed on Jan. 15, 2025.
(60) Provisional application No. 63/745,432, filed on Jan. 15, 2025.
(60) Provisional application No. 63/764,198, filed on Feb. 27, 2025.
(60) Provisional application No. 63/764,198, filed on Feb. 27, 2025.
(60) Provisional application No. 63/765,094, filed on Feb. 28, 2025.
(60) Provisional application No. 63/765,094, filed on Feb. 28, 2025.
(60) Provisional application No. 63/777,814, filed on Mar. 26, 2025.
(60) Provisional application No. 63/777,814, filed on Mar. 26, 2025.
(60) Provisional application No. 63/795,829, filed on Apr. 28, 2025.
(60) Provisional application No. 63/795,829, filed on Apr. 28, 2025.
(60) Provisional application No. 63/797,195, filed on Apr. 30, 2025.
(60) Provisional application No. 63/797,195, filed on Apr. 30, 2025.
(60) Provisional application No. 63/803,977, filed on May 12, 2025.
(60) Provisional application No. 63/803,977, filed on May 12, 2025.
(60) Provisional application No. 63/831,282, filed on Jun. 27, 2025.
(60) Provisional application No. 63/844,802, filed on Jul. 16, 2025.
(60) Provisional application No. 63/844,802, filed on Jul. 16, 2025.
(60) Provisional application No. 63/854,877, filed on Jul. 31, 2025.
(60) Provisional application No. 63/870,916, filed on Aug. 27, 2025.
(60) Provisional application No. 63/899,591, filed on Oct. 15, 2025.
(60) Provisional application No. 63/914,824, filed on Nov. 10, 2025.
(60) Provisional application No. 63/941,793, filed on Dec. 16, 2025.
(60) Provisional application No. 63/983,964, filed on Feb. 16, 2026.
(60) Provisional application No. 64/039,799, filed on Apr. 15, 2026.
(60) Provisional application No. 64/042,050, filed on Apr. 17, 2026.
(60) Provisional application No. 64/057,496, filed on May 5, 2026.

(51) Int. Cl. G06F 17/16

(52) U.S. Cl. CPC G06F 17/16

(57) ABSTRACT

A matrix multiply accelerator (MMA) is accessed. The MMA includes a weight-stationary systolic array. The MMA is coupled to a memory hierarchy that is coupled to a processor core. A first work request is sent to the MMA by the processor core. The sending includes alerting the memory hierarchy of the first work request. The first work request is based on execution of a machine learning model. The memory hierarchy is prefilled with a weight matrix and an activation matrix. The weight matrix and the activation matrix are associated with the first work request that was sent. The weight matrix and the activation matrix are loaded by the MMA from the memory hierarchy, based on the prefilling. The first work request is executed by the MMA. The first work request comprises multiplying the weight matrix by the activation matrix, which results in an answer matrix.

### RELATED APPLICATIONS

This application claims the benefit of U.S. provisional patent applications “Weight-Stationary Matrix Multiply Acceleration With A Prefilled Memory Hierarchy” Ser. No. 63/803,977, filed May 12, 2025, “Single Cycle Move Instruction Elimination With Multiple Dependencies In A Dispatch Bundle” Ser. No. 63/831,282, filed Jun. 27, 2025, “In-Order Multithreading With Dispatch Bundle Packing” Ser. No. 63/844,802, filed Jul. 16, 2025, “AI Compute Clusters With Noncoherent Shared SRAM” Ser. No. 63/854,877, filed Jul. 31, 2025, “In-Order Multithreading With Pipeline Flush And Instruction Replay” Ser. No. 63/870,916, filed Aug. 27, 2025, “Invalidating Snoop Avoidance With Multiple Atomic Loops” Ser. No. 63/899,591, filed Oct.15, 2025, “Matrix Multiply Acceleration Based On A Static Partitioning History Table” Ser. No. 63/914,824, filed Nov. 10, 2025, “Hierarchical Performance-Based Scheduler For Data Center Workloads” Ser. No. 63/941,793, filed Dec. 16, 2025, “Memory Latency Hiding With A Memory Accelerator” Ser. No. 63/983,964, filed Feb. 16, 2026, “Executing Floating Point Instructions In A Plurality Of Formats With Common Hardware” Ser. No. 64/039,799, filed Apr. 15, 2026, “Vector Instruction Execution With Vector Length Set To Zero” Ser. No. 64/042,050, filed Apr. 17, 2026, and “Memory Latency Hiding Based On A Serializing Memory Accelerator” Ser. No. 64/057,496, filed May 5, 2026.

This application is also a continuation-in-part of U.S. patent application “Weight-Stationary Matrix Multiply Accelerator With Tightly Coupled L2 Cache” Ser. No. 19/289,177, filed Aug. 4, 2025, which claims the benefit of U.S. provisional patent applications “Weight-Stationary Matrix Multiply Accelerator With Tightly Coupled L2 Cache” Ser. No. 63/679,192, filed Aug. 5, 2024, “Non-Blocking Vector Instruction Dispatch With Micro-Operations” Ser. No. 63/679,685, filed Aug. 6, 2024, “Atomic Compare And Swap Using Micro-Operations” Ser. No. 63/687,795, filed Aug. 28, 2024, “Atomic Updating Of Page Table Entry Status Bits” Ser. No. 63/690,822, filed Sep. 5, 2024, “Adaptive SOC Routing With Distributed Quality-Of-Service Agents” Ser. No. 63/691,351, filed Sep. 6, 2024, “Communications Protocol Conversion Over A Mesh Interconnect” Ser. No. 63/699,245, filed Sep. 26, 2024, “Non-Blocking Unit Stride Vector Instruction Dispatch With Micro-Operations” Ser. No. 63/702,192, filed Oct. 2, 2024, “Non-Blocking Vector Instruction Dispatch With Micro-Element Operations” Ser. No. 63/714,529, filed Oct. 31, 2024, “Vector Floating-Point Flag Update With Micro-Operations” Ser. No. 63/719,841, filed Nov. 13, 2024, “Shadow Stack Management With Micro-Operations” Ser. No. 63/730,997, filed Dec. 12, 2024, “Systolic Array Matrix-Multiply Accelerator With Row Tail Accumulation” Ser. No. 63/735,937, filed Dec. 19, 2024, “Non-Flushing Vector Micro-Operations With VSET” Ser. No. 63/745,432, filed Jan. 15, 2025, “Precalculated Routing Information In A Coherent Mesh Network” Ser. No. 63/764,198, filed Feb. 27, 2025, “Transformed Activation Function With ISA Extension” Ser. No. 63/765,094, filed Feb. 28, 2025, “Vector Unit With An Activation Function Accelerator Pipeline” Ser. No. 63/777,814, filed Mar. 26, 2025, “Accelerated TAGE Branch Prediction With A TAGE Cache” Ser. No. 63/795,829, filed Apr. 28, 2025, “Branch Prediction With Next Program Counter Caches” Ser. No. 63/797,195, filed Apr. 30, 2025, “Weight-Stationary Matrix Multiply Acceleration With A Prefilled Memory Hierarchy” Ser. No. 63/803,977, filed May 12, 2025, “Single Cycle Move Instruction Elimination With Multiple Dependencies In A Dispatch Bundle” Ser. No. 63/831,282, filed Jun. 27, 2025, “In-Order Multithreading With Dispatch Bundle Packing” Ser. No. 63/844,802, filed Jul. 16, 2025, and “AI Compute Clusters With Noncoherent Shared SRAM” Ser. No. 63/854,877, filed Jul. 31, 2025.

This application is also a continuation-in-part of U.S. patent application “Systolic Array Matrix-Multiply Accelerator With Row Tail Accumulation” Ser. No. 19/424,486, filed Dec. 18, 2025, which claims the benefit of U.S. provisional patent applications “Systolic Array Matrix-Multiply Accelerator With Row Tail Accumulation” Ser. No. 63/735,937, filed Dec. 19, 2024, “Non-Flushing Vector Micro-Operations With VSET” Ser. No. 63/745,432, filed Jan. 15, 2025, “Precalculated Routing Information In A Coherent Mesh Network” Ser. No. 63/764,198, filed Feb. 27, 2025, “Transformed Activation Function With ISA Extension” Ser. No. 63/765,094, filed Feb. 28, 2025, “Vector Unit With An Activation Function Accelerator Pipeline” Ser. No. 63/777,814, filed Mar. 26, 2025, “Accelerated TAGE Branch Prediction With A TAGE Cache” Ser. No. 63/795,829, filed Apr. 28, 2025, “Branch Prediction With Next Program Counter Caches” Ser. No. 63/797,195, filed Apr. 30, 2025, “Weight-Stationary Matrix Multiply Acceleration With A Prefilled Memory Hierarchy” Ser. No. 63/803,977, filed May 12, 2025, “Single Cycle Move Instruction Elimination With Multiple Dependencies In A Dispatch Bundle” Ser. No. 63/831,282, filed Jun. 27, 2025, “In-Order Multithreading With Dispatch Bundle Packing” Ser. No. 63/844,802, filed Jul. 16, 2025, “AI Compute Clusters With Noncoherent Shared SRAM” Ser. No. 63/854,877, filed Jul. 31, 2025, “In-Order Multithreading With Pipeline Flush And Instruction Replay” Ser. No. 63/870,916, filed Aug. 27, 2025, “Invalidating Snoop Avoidance With Multiple Atomic Loops” Ser. No. 63/899,591, filed Oct. 15, 2025, “Matrix Multiply Acceleration Based On A Static Partitioning History Table” Ser. No. 63/914,824, filed Nov. 10, 2025, and “Hierarchical Performance-Based Scheduler For Data Center Workloads” Ser. No. 63/941,793, filed Dec. 16, 2025.

Each of the foregoing applications is hereby incorporated by reference in its entirety.

### FIELD OF ART

This application relates generally to matrix processing and more particularly to weight-stationary matrix multiply acceleration with a prefilled memory hierarchy.

### BACKGROUND

In today's digital world, powerful processors are the backbone of modern applications, enabling seamless performance, rapid data processing, and complex computations. From artificial intelligence and high-resolution gaming to real-time financial analysis and 3D rendering, applications demand immense computational power to function efficiently. Faster processors allow for quicker execution of tasks, reduce latency, and support multitasking, ensuring that users can work, play, and innovate, without frustrating delays. For applications such as cloud computing, video editing, and machine learning, advanced processors can provide the speed and efficiency required for implementation of next-generation technology.

Beyond speed, powerful processors also drive energy efficiency and scalability, enabling applications to run on various devices from smartphones to data centers. Cutting-edge architectures optimize workload distribution, enhancing battery life of mobile devices while ensuring high-performance computing on desktops and servers. This capability is essential for industries like healthcare, cybersecurity, and autonomous vehicles where real-time processing is critical. Without robust processors, innovation in fields such as artificial intelligence, virtual reality, and scientific research would stall, highlighting their indispensable role in powering the digital age. In particular, matrix operations are fundamental to a wide range of applications that rely on complex computations and data transformations. Matrix computations are crucial in powering advanced graphics techniques, enabling realistic visuals and complex rendering effects. Ray tracing, for example, relies on matrices to calculate light paths and reflections, producing stunningly accurate shadows and reflections in modern gaming and computer-generated imagery (CGI). In physics simulations used in gaming, matrices are often employed to represent and compute transformations such as rotation, translation, and scaling of objects in a 3D space. They also play a key role in simulating motion dynamics, such as how objects fall or interact with forces. Image compositing uses matrices to blend multiple layers of visual information, allowing seamless integration of effects such as graphics and images in movies and digital art. Filtering operations, such as sharpening, blurring, and edge detection, can utilize matrix-based convolution techniques to enhance image quality and manipulate textures. Matrix processing plays a vital role in artificial intelligence (AI) acceleration as both training and inference can require thousands, millions, or more matrix multiply calculations. Beyond these, matrices also can enable real-time transformations in 3D rendering, ensuring smooth scaling, rotation, and perspective adjustments for immersive virtual environments. Without efficient matrix operations, these visually stunning and computationally intensive features would be far slower and less realistic. Beyond graphics, matrices can play a key role in signal processing, physics simulations, and engineering applications where they can enable precise modeling of structures, waves, and dynamic systems.

Continuing to develop techniques that can improve processor performance is essential for driving innovation across industries, enabling increasingly complex applications, and enhancing overall efficiency. Faster and more powerful processors allow for breakthroughs in artificial intelligence, scientific simulations, and immersive digital experiences, pushing the boundaries of what technology can achieve. Additionally, optimizing processor architecture and efficiency helps reduce power consumption, which is crucial for sustainable computing, mobile devices, and large-scale data centers. By refining computational techniques, engineers can strike a balance between speed, energy efficiency, and scalability, ensuring that next-generation applications, from advanced robotics to real-time analytics, can operate seamlessly while minimizing environmental impact. As demand for high-performance computing grows, ongoing research and development will remain vital for shaping a future where technology is not only powerful, but also energy-conscious and adaptable to evolving needs.

### SUMMARY

The rise in popularity of artificial intelligence (AI) workloads has been the catalyst for numerous chip and system enhancements. For example, AI accelerators have become necessary to maintain a steady throughput of matrix multiplication operations necessary for today's large language models (LLMs). These operations can require rapid movement of datasets between storage, memory, processing units, the accelerators, and so on. For example, during training, larger AI models can process terabytes of data, requiring robust network infrastructure to prevent performance bottlenecks. As AI models and usage have grown, the need for enhanced bandwidth to and from accelerator units, chips, etc. has only grown. In fact, the performance, scalability, and efficiency and today's AI models can be directly impacted by available bandwidth.

Disclosed embodiments provide a processor-implemented method for matrix processing. A matrix multiply accelerator (MMA) is accessed. The MMA includes a weight-stationary systolic array. The MMA is coupled to a memory hierarchy that is coupled to a processor core. A first work request is sent to the MMA by the processor core. The sending includes alerting the memory hierarchy of the first work request. The first work request is based on execution of a machine learning model. The memory hierarchy is prefilled with a weight matrix and an activation matrix. The weight matrix and the activation matrix are associated with the first work request that was sent. The weight matrix and the activation matrix are loaded by the MMA from the memory hierarchy. The loading is based on the prefilling. The first work request is executed by the MMA. The first work request comprises multiplying the weight matrix by the activation matrix. The multiplying results in an answer matrix.

A processor-implemented method for matrix processing is disclosed comprising: accessing a matrix multiply accelerator (MMA), wherein the MMA includes a weight-stationary systolic array, wherein the MMA is coupled to a memory hierarchy, and wherein the memory hierarchy is coupled to a processor core; sending, by the processor core, a first work request to the MMA, wherein the sending includes alerting the memory hierarchy of the first work request, wherein the first work request is based on execution of a machine learning model; prefilling the memory hierarchy with a weight matrix and an activation matrix, wherein the weight matrix and the activation matrix are associated with the first work request that was sent; loading, by the MMA, the weight matrix and the activation matrix from the memory hierarchy into the MMA, wherein the loading is based on the prefilling; and executing the first work request, by the MMA, wherein the first work request comprises multiplying the weight matrix by the activation matrix, and wherein the multiplying results in an answer matrix. In embodiments, the prefilling is accomplished by the processor core. In embodiments, the prefilling comprises prefetching the weight matrix and the activation matrix. In embodiments, the memory hierarchy includes an L2 cache, wherein the L2 cache includes a dedicated port, wherein the prefetching uses the dedicated port. In embodiments, the sending includes a second work request. Some embodiments comprise pipelining the first work request and the second work request.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for weight-stationary matrix multiply acceleration with a prefilled memory hierarchy.

FIG. 2 is a flow diagram for pipelining work requests.

FIG. 3 is a block diagram of a matrix multiply accelerator.

FIG. 4 is a block diagram for weight-stationary matrix multiply acceleration with a prefilled memory hierarchy.

FIG. 5 is a block diagram of a multi-core processor tile including a cache coherency block.

FIG. 6 is an example M×N mesh.

FIG. 7 is a block diagram of a multicore processor.

FIG. 8 is a block diagram of a pipeline.

FIG. 9 is a design flow for semiconductor logic generation.

FIG. 10 is a system diagram for weight-stationary matrix multiply acceleration with a prefilled memory hierarchy.

### DETAILED DESCRIPTION

In machine learning and artificial intelligence, matrices are an important component of algorithms that process vast amounts of data. Neural networks, for example, rely on matrix multiplications for forward and backward propagation, enabling pattern recognition and decision making in everything from image classification to natural language processing. Efficient matrix computations directly impact the speed and accuracy of AI models, influencing advancements in areas such as autonomous vehicles, medical diagnostics, and financial forecasting. As the demand for high-performance computing continues to grow, optimizing matrix operations remains essential in pushing the boundaries of technology while maintaining scalability and efficiency. Unfortunately, most general purpose processors are not well suited for these types of calculations. Further, AI calculations can be bandwidth limited. Thus, even systems, racks, and data centers of expensive AI accelerators must be equipped with enough memory bandwidth to be effective at keeping up with AI demand.

Disclosed implementations provide a processor that integrates a matrix multiply accelerator with a bandwidth-savvy cache memory that can leverage a weight-stationary systolic array. This configuration can offer significant advantages for AI and high-performance computing applications. Disclosed implementations can enhance computational efficiency by minimizing data movement, a key bottleneck in matrix-heavy workloads such as deep learning. By first loading a weight matrix into the accelerator and then streaming activation matrices through the cache, disclosed implementations can optimize memory access patterns, reducing latency and energy consumption. The systolic array architecture ensures that data flows efficiently through processing elements, enabling high-throughput matrix multiplications that are essential for AI inference and training. The weight-stationary approach, where weights remain in place while activations move through the array, further reduces memory bandwidth requirements, making the system both power-efficient and scalable. The ability to perform matrix operations efficiently is critical for a wide variety of fields, ensuring quick calculations without excessive computational costs. Additionally, the pipelined operation enables continuous computation, allowing the processor to fetch new activation matrices while the accelerator processes existing matrices. This overlapping of data loading and computation can significantly boost throughput, making the architecture well suited for AI workloads that demand rapid processing of large datasets, such as computer vision, natural language processing, and scientific simulations. The close integration of cache memory with the accelerator reduces delays caused by frequent memory accesses, maximizing parallelism and minimizing stalls. Ultimately, this architecture can enable AI models to run more efficiently on edge devices, mobile hardware, and cloud-based systems, advancing the capabilities of machine learning while maintaining energy efficiency.

Disclosed implementations provide matrix multiply acceleration in a system that includes a mesh of tiles. A matrix multiply accelerator (MMA) is accessed, where the MMA includes a weight-stationary systolic array. The MMA is coupled to a memory hierarchy. The memory hierarchy is coupled to a processor core. The processor core sends a first work request to the MMA. The sending includes alerting the memory hierarchy of the first work request. The first work request is based on execution of a machine learning model. A weight matrix and an activation matrix are prefilled based on the first work request. The prefilling can be accomplished by the processor core and can comprise prefetching the weight matrix and the activation matrix. The weight matrix and the activation matrix are loaded into the MMA. The MMA executes the first work request which includes multiplying the weight matrix by the activation matrix, resulting in an answer matrix. A second work request can be included. The first work request and the second work request can be pipelined. The accelerator can be included on a system-on-chip (SoC). The SoC can include a plurality of cache coherency blocks (CCBs). Each CCB can be located on a unique tile within an M×N mesh of tiles.

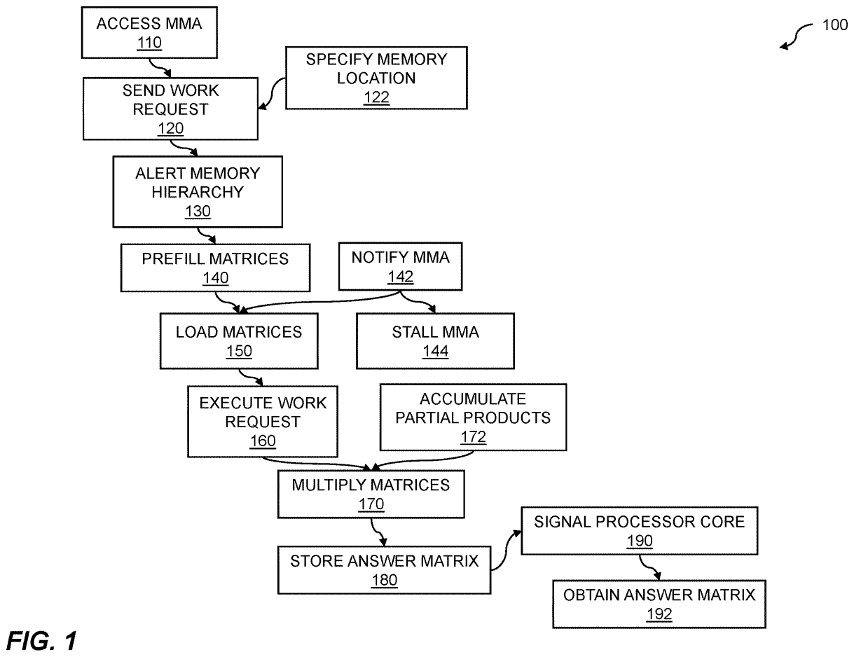

FIG. 1 is a flow diagram for weight-stationary matrix multiply acceleration with a prefilled memory hierarchy. The flow 100 starts with accessing a matrix multiply accelerator 110. Embodiments can include accessing a matrix multiply accelerator (MMA), wherein the MMA includes a weight-stationary systolic array, wherein the MMA is coupled to a memory hierarchy, and wherein the memory hierarchy is coupled to a processor core. A systolic array is a specialized hardware architecture used in computer chips to perform highly parallel and efficient data processing, and is especially well suited for operations such as matrix multiplication. It can include a grid of processing elements (tiles) that synchronously computes and passes intermediate data to neighboring elements in a “pipelined” fashion. One key advantage of disclosed implementations is the use of a systolic array for matrix multiplication, which enables the ability to reuse data locally, minimizing access to slower, off-chip memory. In disclosed implementations, one matrix (such a weight matrix in deep learning) is “stationary” within the array, while the other (such as an activation matrix) flows through the array. This dataflow model can reduce memory bandwidth requirements and improve throughput, making disclosed implementations well suited for AI workloads, where repeated matrix operations are common. Thus, disclosed implementations can enable energy-efficient and scalable performance in dedicated accelerators.

The flow 100 continues with sending a work request 120. Embodiments can include sending, by the processor core, a first work request to the MMA, wherein the sending includes alerting the memory hierarchy 130 of the first work request, wherein the first work request is based on execution of a machine learning model. Disclosed implementations provide a processor that interfaces with a matrix multiply accelerator (MMA) based on systolic array technology. This arrangement can achieve significant performance and efficiency gains, particularly in workloads dominated by matrix operations, such as machine learning and scientific computing. In disclosed implementations, the processor can issue commands to the MMA, which can include activation and/or weight matrices, one or more memory locations at which an activation and/or weight matrix is stored, and so on. These requests offload compute-intensive matrix multiplications to the MMA, allowing the processor to focus on control flow, data orchestration, and/or other general-purpose tasks. The MMA, leveraging the parallelism and data reuse characteristics of systolic arrays, performs matrix operations with high throughput and low latency. This division of labor can enhance overall system efficiency by reducing memory bandwidth consumption and maximizing concurrency. Additionally, the ability to queue or pipeline requests from the processor enables continuous operation of the MMA, maintaining a steady computational rhythm. This architecture is especially beneficial in power-constrained and/or resource-constrained environments, enabling scalable and energy-efficient performance across a wide range of AI and signal processing applications. The memory hierarchy can include L1, L2, and L3 caches, memory, and so on. The memory hierarchy can be coherent or non-coherent. The memory hierarchy can be included on a tile within a network, such as a mesh network. Other tiles within the network can include another memory hierarchy. The work request is based on execution of a machine learning model (ML model). The ML model can comprise any type of model such as a neural network, convolutional neural network, large learning model (LLM), small learning model (SLM), and so on.

The flow 100 can include specifying a memory location 122. The first work request specifies a memory location of the weight matrix and a location of the activation matrix. In disclosed implementations, the processor may generate a work request for the matrix multiply accelerator (MMA) by passing a structured set of arguments that enable flexible and efficient coordination. These arguments can include memory addresses pointing to a list of activation matrices and/or weight matrices. The matrices can be of any size suitable for the size and structure of the MMA. The matrices can comprise any type of data formats suitable to the MMA, such as FP16, FP32, BF16, etc. The request can include batching of multiple computations in a single request, maximizing accelerator utilization. Additional metadata, such as a priority level, a process ID, an origination ID, etc., can be included to facilitate scheduling, context-aware resource allocation, and tracking across concurrent workloads. This approach can allow the MMA to handle multiple outstanding requests intelligently, supporting high-throughput and scalable matrix operations while reducing processor intervention.

The flow 100 includes alerting the memory hierarchy 130. The processor core can alert components of the memory hierarchy, such as memory controllers, DMA engines, and/or cache controllers, when dispatching a matrix multiplication request to the MMA. The alerting can put in motion data movement ahead of time (e.g., before the data is needed by the work request). The processor can initiate prefetching of the required activation and weight matrices into a shared L2 cache that is accessible to the MMA. This proactive data staging minimizes latency and ensures that the systolic array within the MMA can begin computations quickly, sustaining high throughput and reducing idle cycles associated with memory fetch delays.

The flow 100 includes prefilling matrices 140. Embodiments include prefilling the memory hierarchy with a weight matrix and an activation matrix, wherein the weight matrix and the activation matrix are associated with the first work request that was sent. Prefilling matrix data into a cache, such as an L2 cache, can provide a major performance advantage by significantly reducing the latency between data availability and computational execution. In embodiments, the prefilling is accomplished by the processor core. In a normal process, the MMA can request data from the memory hierarchy. If not available, the MMA must wait until data is fetched from a shared cache on a mesh network, main memory, disk, etc. This can cause the MMA to stall for many cycles. Prefilling can hide that latency while other operations continue in the MMA. In embodiments, the prefilling comprises prefetching the weight matrix and the activation matrix. When weight and activation matrices are preloaded into the cache before the MMA begins processing, the systolic array can access data quickly, avoiding costly delays that would otherwise occur if data had to be retrieved from main memory. This can improve overall throughput, support sustained high-performance compute cycles, and maximize utilization of the matrix multiply accelerator's pipeline.

The flow 100 can include notifying the MMA 142. Embodiments include notifying the MMA, by the memory hierarchy, when the prefilling is complete. Allowing the memory hierarchy, such an L2 cache, to notify the matrix multiply accelerator (MMA) when prefilling is complete can ensure that the MMA begins matrix multiplication only when all required data is locally available, avoiding stalls or partial computations. Such coordination is especially beneficial when executing a sequence of multiplications, as it enables seamless transitions between computation phases, reduces idle time in the MMA, and enhances pipeline efficiency across the entire data processing and execution workflow. For example, the MMA can perform one or more matrix multiply operations while the memory hierarchy is prefilled with data for the next operation. In embodiments, the memory hierarchy includes an L2 cache, wherein the L2 cache includes a dedicated port, wherein the prefetching uses the dedicated port. A dedicated port may be necessary so the L2 can continue other cleanup functions such as validation, invalidation of lines to maintain coherency, writing dirty data back to the rest of the memory hierarchy, casting out lines to create new space, and so on.

The flow 100 can include stalling the MMA 144. Embodiments include stalling, by the MMA, wherein the stalling is based on the notifying. In some cases, the memory hierarchy may not be able to keep the MMA fully loaded. Disclosed implementations can provide a feature where the matrix multiply accelerator (MMA) automatically stalls when required data is not immediately available. In this case, work requests can be saved in a buffer for execution when the memory hierarchy signals that the prefill corresponding to a work request is complete. This feature can enhance system resilience and efficiency. During such stalls, the systolic array may continue to clock at a reduced rate to conserve power, avoiding unnecessary energy consumption while waiting for data to arrive. Once the needed data becomes available, such as after a cache or memory prefill operation, the MMA can resume full-speed operation seamlessly. This dynamic clock scaling balances energy efficiency with performance, ensuring that the accelerator is optimally utilized without wasting cycles or power. In disclosed implementations, the reduced clock speed for use when the MMA has no data is one half the normal operating clock speed of the MMA.

The flow 100 includes loading matrices 150. Embodiments include loading, by the MMA, the weight matrix and the activation matrix from the memory hierarchy into the MMA, wherein the loading is based on the prefilling. Once sufficient matrix data has been prefetched into the memory hierarchy, such as the L2 cache, the matrix multiply accelerator (MMA) can rapidly load the activation and weight matrices into its internal buffers or registers. This proximity of data minimizes memory access latency and allows the MMA to quickly initiate high-throughput matrix multiplication operations. The close coupling between the L2 cache and the MMA ensures that data transfer occurs with minimal delay, enabling efficient pipeline utilization and maintaining a steady flow of computation without processor intervention.

The flow 100 includes executing the work request 160. Embodiments include executing the first work request, by the MMA, wherein the first work request comprises multiplying the weight matrix by the activation matrix, and wherein the multiplying results in an answer matrix. In disclosed implementations, the MMA performs matrix multiplication by processing two input matrices to generate an answer matrix, leveraging the structured dataflow of a systolic array. One of the matrices, often the weight matrix, can be held stationary within the processing elements (tiles) of the systolic array, remaining fixed for the duration of the computation. The other matrix, such as the activation matrix, is clocked through the array, element by element, in a pipelined fashion (described later).

The flow 100 can include multiplying matrices 170. As each activation value passes through the systolic array of the MMA, it is multiplied with the corresponding stationary weight to produce the multiplication. The flow 100 includes accumulating partial products 172. In embodiments, the multiplying is based on a plurality of partial products. When performing matrix multiplication, the use of partial products is useful for optimizing throughput and reducing complexity in hardware such as a systolic array. Each partial product can represent an intermediate result of multiplying a single element from the stationary matrix (e.g., weight) with an element from the flowing matrix (e.g., activation). In embodiments, one or more row tails within the MMA accumulate the one or more partial products. By computing and accumulating these partial products across multiple processing elements in parallel, disclosed implementations can avoid redundant calculations and promote pipelined data flow. Thus, disclosed implementations can enable high-performance, scalable matrix multiplication with efficient resource utilization and minimized latency.

The flow 100 includes storing an answer matrix 180. Embodiments include storing, by the MMA, the answer matrix in the memory hierarchy. In disclosed implementations, once the matrix multiplication operation is completed by the MMA, the resulting answer matrix is stored in the memory hierarchy, such as the L2 cache. This placement ensures that the answer matrix is readily available for fast access by the processor for subsequent operations, minimizing latency. By leveraging the L2 cache, the system can quickly retrieve the computed results without needing to access slower off-chip memory, thereby enabling faster decision making and reducing the overall time required for processing further tasks in AI and high-performance computing applications. In embodiments, the weight matrix remains loaded in the weight-stationary systolic array. Keeping the weight matrix loaded in the systolic array can produce fast back-to-back multiplication of the weight matrix by more than one activation matrix.

The flow 100 includes signaling a processor core 190. Embodiments include signaling, to the processor core, by the MMA, when the storing is complete. In disclosed implementations, once the MMA completes the matrix multiplication and stores the answer matrix in the memory hierarchy, it generates a signal to notify the processor core that the result is available. The signaling can comprise a semaphore, an interrupt, and so on. The signaling can comprise a location in the memory hierarchy where the processors can fetch the result matrix. Other information regarding the result matrix, such as size, data types, etc., can be specified. This approach allows the processor to focus on other tasks in parallel, improving overall system efficiency. When the signal is received, the processor can then retrieve the answer matrix from the memory hierarchy. This signal can be implemented using various techniques, such as a logic level change on an I/O signal, a hardware semaphore, and/or another suitable method.

The flow 100 includes obtaining the answer matrix 192. Embodiments can include obtaining, by the processor core, from the memory hierarchy, the answer matrix. Once the processor receives the signal from the MMA indicating that the answer matrix is available, it can access the matrix from the memory hierarchy. This allows the processor to efficiently retrieve the result and use it for further computations, such as executing a machine learning model. By offloading the matrix multiplication to the MMA, the processor can focus on other aspects of the model's execution while waiting for the result, improving overall throughput and enabling faster processing for machine learning tasks.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

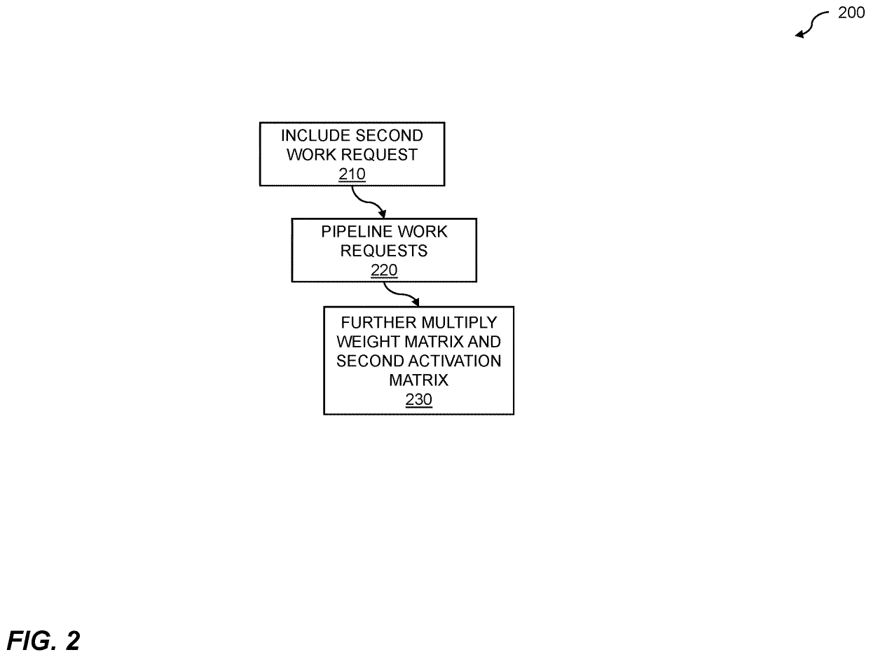

FIG. 2 is a flow diagram for pipelining work requests. Disclosed implementations, such as is shown in the flow 200, can support issuing a second work request from the processor to the matrix multiply accelerator (MMA). The second request can specify additional matrices, such as one or more new activation matrices, a new weight matrix, the same weight matrix as the first work request, and so on. When the same weight matrix is used, a second activation matrix can be multiplied by the weight matrix already loaded into the MMA by the first work request. Alternatively, the MMA can multiply the second matrix with a new weight matrix, another activation matrix, or any other matrix specified by the second work request. A key advantage of this approach is the pipelined operation it enables while the MMA is busy performing computations from the first work request. The memory hierarchy (e.g., cache controllers and/or DMA engines) can begin fetching and preloading matrix data for the second request into the cache. This overlapping of data movement and computation can boost overall throughput and minimize idle time. The system can continue this process for third, fourth, and subsequent work requests, facilitating sustained high-performance execution for workloads such as deep learning model inference and/or training that require repeated matrix operations.

In disclosed implementations, the matrices operated on by the MMA can be used to execute a machine language (ML) model. The ML model can comprise a neural network, a large language model (LLM), a small language model (SLM), or any other suitable ML model. The MMA can be a part of a system that is used to process training or inferences for the ML model. Matrices associated with models such as these can contain numerical values representing neuron activations, can comprise floating-point formats such as FP32 for training, and may use lower-precision types such as BF16, FP16, or INT8 for inference.

In embodiments, the sending includes a second work request 210. Any number of work requests can be sent to the MMA from the processor. As additional work requests are sent by the processor core, they can be stored by the MMA. The storing can be accomplished with a buffer, a circular buffer, a register, or any other type of memory. The buffer can be sized to store any number of work requests. Like the first work request, the second work request can specify one or more matrices. In embodiments, the prefetching includes a second activation matrix, wherein the second activation matrix is specified by the second work request.

Embodiments include pipelining the first work request and the second work request 220. In embodiments, the prefetching includes a second activation matrix, wherein the second activation matrix is specified by the second work request. The second work request can be prefetched while the first work request executes. In embodiments, the prefetching of the second activation matrix occurs during the executing of the first work request. Alternatively, the second work request can be prefetched or at any time before, during, or after execution of the first work request. Any number of matrices associated with work requests can be prefetched at any time. Prefetching can reduce latency by avoiding overhead associated with a cache miss in the memory hierarchy. Since the MMA can perform a matrix multiply function faster than the memory can load any necessary arrays (in the case of a cache miss), latency can be further minimized by prefetching multiple requests prior to the start of execution. In a usage example, matrices associated with ten work requests can be prefetched prior to execution.

The flow 200 includes further multiplying the weight matrix and second activation matrix 230. Once prefetched (e.g., prefilled), the second activation matrix can be multiplied by the weight matrix that was already loaded into the MMA. Alternatively, the second work request can specify two new matrices, and both can be prefetched by the processor core prior to execution of the second work request. The multiplying is accomplished by the MMA and can be based on partial products (described below). The systolic array within the MMA can enable pipelined multiplication of two arrays. In embodiments, the multiplying includes further multiplying the weight matrix and the second activation matrix, wherein the further multiplying results in a second answer matrix. As in the case of the first answer matrix, the second answer matrix can be stored in the memory hierarchy and accessed by the processor core.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

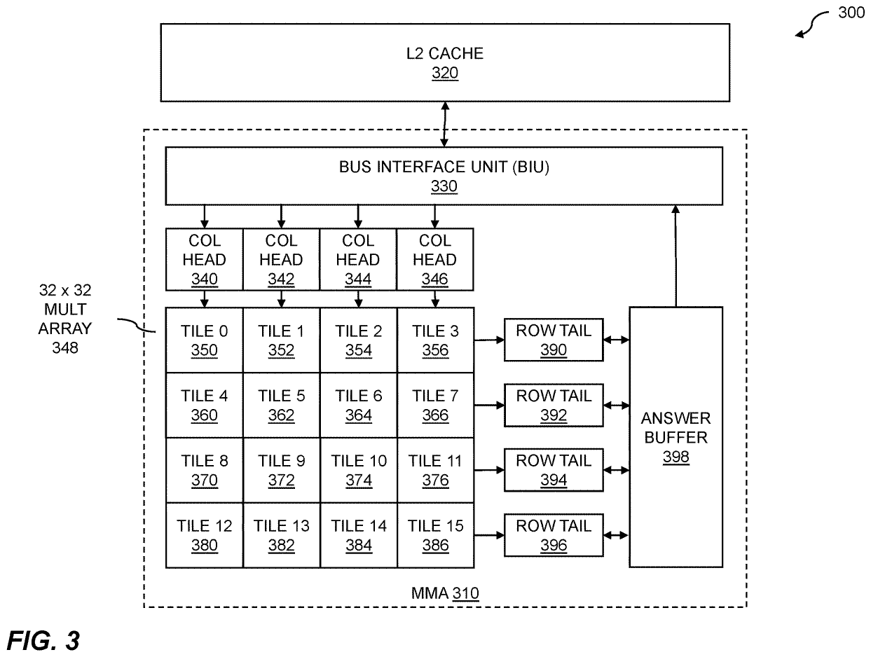

FIG. 3 is a block diagram of a matrix multiply accelerator. The block diagram 300 shows a 32×32 systolic array 348 which can be coupled to a memory hierarchy. The memory hierarchy can include an L2 cache 320. The L2 cache 320 can be tightly coupled to a processor core to enable fast data sharing between the matrix multiply accelerator (MMA) 310 and a processor core. The L2 cache can be coherent. The memory hierarchy can include any number of caches, main memory, disk storage, and so on. The accelerator can include a bus interface unit (BIU) 330. The BIU 330 can provide control for communications between the accelerator and the L2 cache. These communications can include loading a weight matrix, loading an activation matrix, storing an answer matrix, and so on. The accelerator can include one or more column headers. The column headers are shown at 340, 342, 344, and 346 on block diagram 300. The column headers can load data from one or more matrices from the BIU 330 into an array within the accelerator. The column headers can unpack data from the BIU 330 into an internal input format. In exemplary implementations, the internal input format can include a quintuple format. In exemplary implementations, the quintuple format can include a valid bit, a sign bit, nine signed exponent bits, eight significant bits, and two status bits. The column headers can shift data into the array in a staggered manner. The shifting can be based on one or more registers to ensure that timing requirements are met due to long RC delays down columns of the array. The array can comprise a grid of 16 tiles as shown in block diagram 300. Each tile can include eight multiply-add units. Thus, the entire array can comprise a 32×32 systolic array 348. Each multiply-add unit can comprise a vector dot product engine that can perform a dot product operation on BF16 data types, MXFP8, MXFP6, MXFP4, INT8, and/or other suitable data types.

In exemplary implementations, each of the eight vector dot product engines within each of the 16 tiles can be called a VDP16. In embodiments, the multiplying is based on a plurality of partial products. Results from each multiply-add (or VDP16) can be summed and added across the array. The final partial product results can be saved in a row tail. In embodiments, one or more row tails within the MMA accumulate the one or more partial products. Thus, as shown in block diagram 300, a first row in the multiply-add array can create partial products corresponding to a first portion of the 32 dot products via tiles 350, 352, 354, and 356. The results of the first row of tiles can be summed and saved in the row tail 390. A second row in the multiply-add array can create partial products corresponding to a second portion of the 32 dot products via tiles 360, 362, 364, and 366. The results of the second row of tiles can be summed and saved in the row tail 392. A third row in the multiply-add array can create partial products corresponding to a third portion of the 32 dot products via tiles 370, 372, 374, and 376. The results of the third row of tiles can be summed and saved in the row tail 394. A fourth row in the multiply-add array can create partial products corresponding to a fourth portion of the 32 dot products via tiles 380, 382, 384, and 386. The results of the fourth row of tiles can be summed and saved in the row tail 396. Using the structure shown in block diagram 300, the accelerator can load a 32×32 weight matrix into the array, load a 32×32 activation matrix into the array, and perform the matrix multiplication by using the multiply-add arranged in disclosed rows and columns. In embodiments, one or more row tails within the MMA accumulate the plurality of partial products.

The systolic array can be pipelined. This can be performed in addition to the pipelining of the work requests. Each cycle of the systolic array can start an additional multiplication of an additional activation matrix by the loaded weight matrix. For example, on a first cycle, column header 340 can send an activation to tile 0 which can determine a first partial product according to a first multiplication. Results can be forwarded by tile 0 to tile 1, where it can be saved for use in the next cycle. During a second cycle, multiple actions can occur. Column header 340 can send a second activation to tile 0 which can determine a first partial product according to a second multiplication. The second activation can be prefetched. Also in the second cycle, tile 1 can execute the second partial product of the first multiplication, accumulating results with those that were forwarded by tile 0 in the previous cycle. Finally, in the same cycle, column header 340 can send another activation corresponding to the first multiplication to tile 4. Since each row can work on four partial products, the column header can send tile 4 an activation associated with a fifth partial product. In this way, multiple multiplications can proceed in a “diagonal wave” across the systolic array. When the array comprises a 4×4 array of tiles, the array can be pipelined to operate on four multiplications at once. The row tails can send results to a corresponding answer buffer location within answer buffer 398, which can save one or more answer matrices from one or more matrix-multiply functions. The BIU 330 can store one or more answer matrices back to the memory hierarchy. One or more implementations can include more or fewer rows and columns than depicted in FIG. 3. In disclosed implementations, the processor core can prefetch (e.g., prefill) any number of matrices associated with any number of work requests. For maximum efficiency, the systolic array can be “warmed up.” That is, since the array is pipelined, multiple arrays can be prefetched to fill the array while additional matrices are prefilled in the L2. In this way, once warm, the systolic array can perform sustained back-to-back matrix multiplications.

The row tails and/or answer buffers can send data back to the BIU 330 to get the answer results to the L2 cache 320 so that the results can be made available to the processor. Moreover, a signaling protocol may be used to signal to a processor that new data is available. The data may arrive at the output block in a staggered manner. Thus, in embodiments, the sending is staggered between the associated row tail and the second associated row tail, wherein the staggering is based on a clock cycle of the accelerator. The answer buffer 398 may include logic to temporally destagger the output by collecting the entire answer matrix in an output block over a number of clock cycles. Thus, embodiments can include destaggering the result of the accumulating and the second result of the accumulating, wherein the destaggering results in a final answer. Once the answer buffer contains a complete answer matrix, the answer buffer provides the answer matrix data to the bus interface unit. The bus interface unit then loads the answer matrix data in the L2 cache, where it can be consumed by the processor.

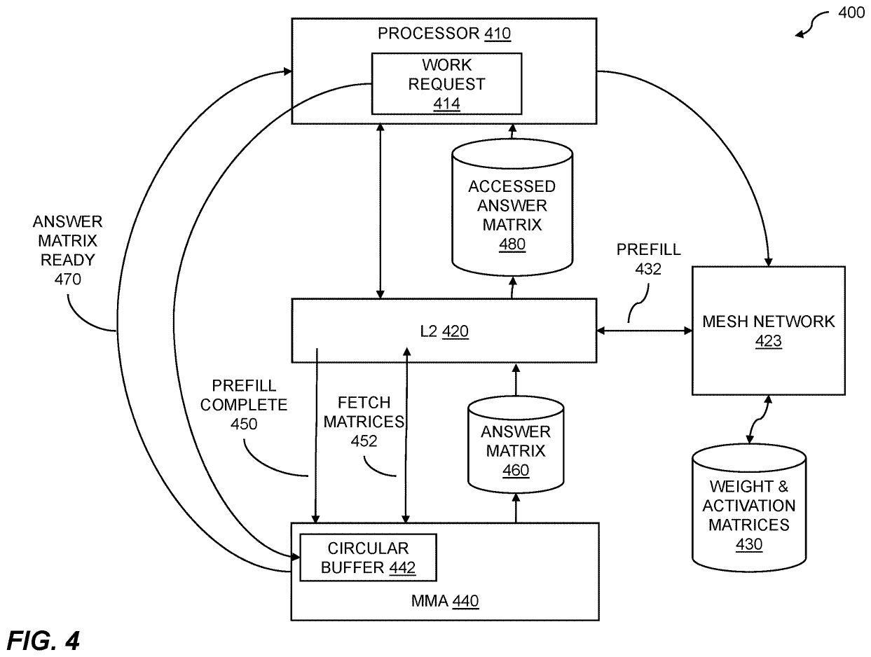

FIG. 4 is a block diagram for weight-stationary matrix multiply acceleration with a prefilled memory hierarchy. The diagram 400 includes a processor core 410. The processor core can include a RISC-V® processor, MIPS® processor, ARM® processor, x86® processor, or other suitable processor type. The processor core can include a module 414 for issuing work requests. The work requests, which can include a first work request, can include memory locations for matrices that are to be loaded into an MMA 440 for multiplying. In embodiments, the first work request specifies a memory location of the weight matrix and a location of the activation matrix. Work requests that are issued from the work request module can be input to circular buffer 442 within the MMA. In exemplary implementations, the circular buffer includes multiple entries, and therefore has the capability to store multiple work requests. Thus, in exemplary implementations, the work requests can be queued. Each work request can include information such as addresses for weight and activation matrices, lists of matrix addresses, priority values, process identifiers, and additional metadata. The circular buffer structure allows the MMA to maintain a continuous pipeline of pending operations, enabling seamless transitions between requests without waiting for new commands from the processor after each multiplication task. Using a circular buffer provides several advantages. It allows non-blocking, asynchronous operation, where the processor can offload multiple requests and return to other tasks. The MMA can independently consume work requests at its own pace, ensuring high hardware utilization and reduced idle time. Additionally, it helps maintain order and fairness in request handling while allowing for efficient arbitration of multiple queued operations. This queuing mechanism is especially valuable in high-throughput applications like deep learning inference or training, where matrix multiplications are frequent and latency-sensitive.

The work request from work request module 414 can also send messages to the memory hierarchy, such as L2 cache 420, to initiate a prefill operation 432. In embodiments, the prefilling is accomplished by the processor core. In embodiments, the prefilling comprises prefetching the weight matrix and the activation matrix. The prefilling operation can obtain data from a mesh network 423, which has access to weight and activation matrices 430. The prefill operation can include loading weight matrices, activation matrices, and/or other matrices. Disclosed implementations can be used with other matrices besides weight matrices and activation matrices. The other matrices can include bias matrices, which are typically added after multiplication to shift the output values, and embedding matrices, which map discrete input tokens (such as words or IDs) into continuous vector spaces. Additionally, positional encoding matrices can be used in transformer models to provide sequence order information, and projection matrices can be applied in attention mechanisms to generate query, key, and value representations. Each of these matrices can play important roles in enabling rich, high-dimensional computations for machine learning models.

Once the prefill operation is complete, the memory hierarchy (which can comprise an L2 cache 420) can generate a prefill complete signal 450 which is received by the MMA 440. Embodiments include notifying the MMA, by the memory hierarchy, when the prefilling is complete. In response to receiving the prefill complete signal 450, the MMA 440 can fetch the matrices 452 from the L2 cache 420. The MMA performs a matrix multiplication such as previously described for FIG. 3. In embodiments, the multiplying is based on a plurality of partial products. In embodiments, one or more row tails within the MMA accumulate the one or more partial products. The resulting answer matrix 460 is then loaded into the L2 cache 420. Embodiments include storing, by the MMA, the answer matrix in the memory hierarchy. Once the answer matrix 460 is loaded into L2 cache 420, an answer matrix ready signal 470 is generated by the MMA 440 and received by the processor 410. Embodiments include signaling, to the processor core, by the MMA, when the storing is complete. In response to receiving the answer matrix ready signal 470, the processor 410 can obtain the accessed answer matrix 480 from the L2 cache 420. Embodiments include obtaining, by the processor core, from the memory hierarchy, the answer matrix.

In disclosed implementations, the accessed answer matrix 480 can be the same data as answer matrix 460. In disclosed implementations, the accessed answer matrix 480 can include different data than answer matrix 460. In a pipelined operation, the MMA 440 can be outputting answer matrix 460 to the L2 cache 420 while the processor retrieves answer matrix 480 from the L2 cache 420. In general, the processor can be retrieving answer matrix X from the L2 cache 420 while the MMA 440 is loading answer matrix X+1 (the next answer matrix) into the L2 cache 420. In disclosed implementations, the L2 cache is equipped with sufficient ports to enable this functionality. The process described can repeat over the course of multiple work requests, to implement pipelined execution of machine learning models.

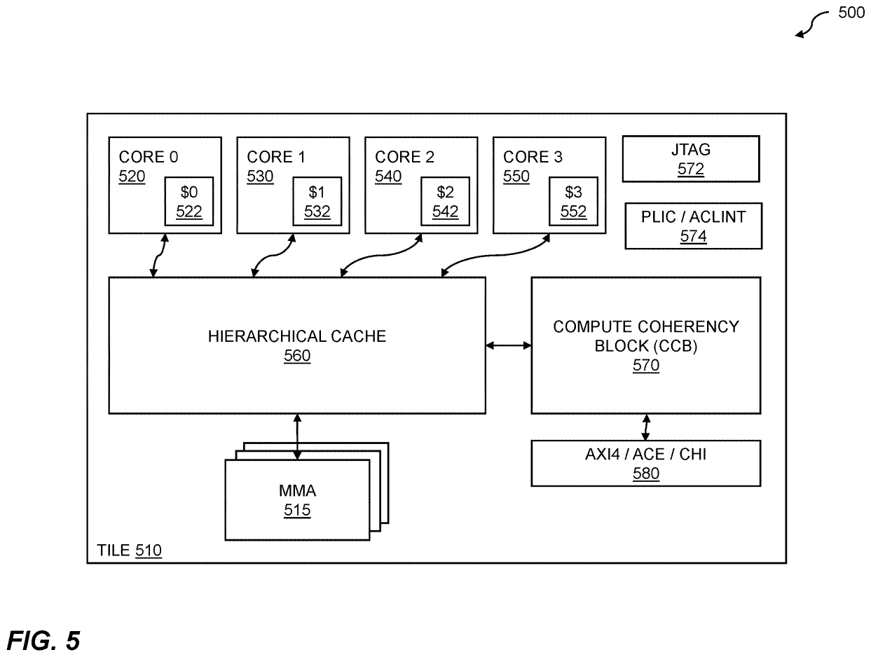

FIG. 5 is a block diagram 500 of a multi-core processor tile including a cache coherency block. The processor core, MMA, memory hierarchy, etc. of disclosed embodiments can be implemented within a multicore processor. The multicore processor can comprise a tile 510 within a mesh network of tiles. The multicore processor tile 510 includes core 0 520, core 1 530, core 2 540, and core 3 550. While four cores are shown in block diagram 500, in practice, there can be more or fewer cores. As an example, disclosed embodiments can include 16, 32, or 64 cores. Each core comprises an onboard local cache, which is referred to as a level 1 (L1) cache. Core 0 520 includes local cache 522, core 1 530 includes local cache 532, core 2 540 includes local cache 542, and core 3 550 includes local cache 552.

The multicore processor tile 510 can further include a joint test action group (JTAG) element 572. The JTAG element 572 can be used to support diagnostics and debugging of programs and/or applications executing on the multicore processor tile 510 by providing access to the processor's internal registers, memory, and other resources. In embodiments, the JTAG element 572 enables functionality for step-by-step execution, setting breakpoints, examining the processor's state during program execution, and/or other relevant functions. The multicore processor tile 510 can further include a PLIC/ACLINT element 574. As stated previously, the PLIC (a platform level interrupt controller), and/or ACLINT (advanced core local interrupter) support features including, but not limited to, interrupt processing and timer functionalities. The multicore processor tile 510 can further include a hierarchical cache 560. The hierarchical cache 560 can be a level 2 (L2) cache that is shared among multiple cores within multicore processor tile 510. In one or more embodiments, the hierarchical cache 560 is a last level cache (LLC). The multicore processor tile 510 can further include one or more interface elements 580, which can include standard processor interfaces such as an Advanced eXtensible Interface (AXI®) including AXI4®, an ARM® Advanced eXtensible Interface (AXI®) Coherence Extensions (ACE®) interface, an Advanced Microcontroller Bus Architecture (AMBA®) Coherence Hub Interface (CHI®).

The multicore processor tile 510 further includes a compute coherency block (CCB) 570. In one or more embodiments, the compute coherency block (CCB) 570 is responsible for maintaining coherency between one or more caches such as local caches associated with the processor cores and the shared memory system. In embodiments, the CCB 570 interfaces to the hierarchical cache 560 and the interface elements 580. The compute coherency block can perform one or more cache maintenance operations such as writing back “dirty” data in one or more caches or memory. The dirty data can result from changes to the local copies of shared memory contents in the local caches. The changes to the local copies of data can result from processing operations performed by the processor cores as the cores execute code. Similarly, data in the shared memory can be different from the data in a local cache due to an operation such as a write operation.

The hierarchical cache 560 can be coupled to one or more MMAs 515. Each MMA can include components similar to those shown in FIG. 3. In embodiments, the MMA is included within a system-on-chip (SoC), wherein the SoC includes a plurality of cache coherency blocks (CCBs), wherein each CCB within the plurality of CCBs is located on a unique tile within an M×N mesh of tiles. In embodiments, each CCBs within the M×N mesh CCBs includes one or more processor cores and at least one MMA. In embodiments, at least one tile with the M×N mesh of tiles includes a memory controller. The MMAs can provide hardware-accelerated matrix multiplication to provide hardware that is well suited for machine learning applications.

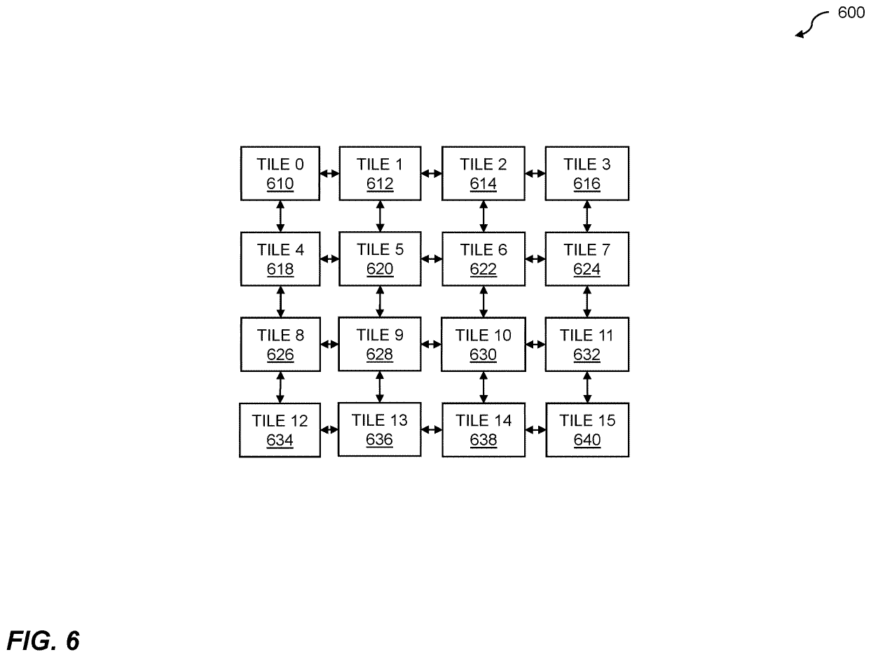

FIG. 6 is an example M×N mesh. As described above, a multicore processor can be implemented as a tile within a mesh of tiles. The tiles can be coherent. Each multicore processor can include any number of processor cores, any number of MMAs, a memory hierarchy, and a CCB which can interface with other tiles in the mesh. The mesh can comprise a system-on-a-chip (SoC). In embodiments, the MMA is included within a system-on-chip (SoC), wherein the SoC includes a plurality of cache coherency blocks (CCBs), wherein each CCB within the plurality of CCBs is located on a unique tile within an M×N mesh of tiles. In embodiments, each CCB within the M×N mesh CCBs includes one or more processor cores and at least one MMA. As shown in example 600, the values of M and N are both equal to 4. However, in one or more embodiments, M and/or N can be larger or smaller than 4. In one or more embodiments, M may be unequal to N. Tiles can be configured in an M×N mesh topology. The example 600 shows a 4×4 mesh. The tiles within the mesh can include tiles such as tile 0 610, tile 1 612, tile 2 614, tile 3 616, tile 4 618, tile 5 620, tile 6 622, tile 7 624, tile 8 626, tile 9 628, tile 10 630, tile 11 632, tile 12 634, tile 13 636, tile 14 638, and tile 15 640. A coherent tile can be located at any point of the M×N mesh topology. The coherent tile can comprise a switching unit (SU). A switching unit, which can also be referred to as a mesh switch unit, can include one or more of a memory controller interface (MCI), an input/output (I/O) mesh interface (IMI), and so on. In embodiments, at least one tile within the M×N mesh of tiles includes a memory controller. Each coherent tile can include a plurality of ports. The ports can include local ports, directional ports, and the like. The ports can be used for communication with other coherent tiles within the mesh. Each switching unit can be in communication with nearest-neighbor tiles within the matrix. Communication with nearest-neighbor tiles can be accomplished using a network-on-chip (NoC). The network-on-chip can be based on techniques including router-based packet switching.

The tiles within the mesh need not be identical. Some tiles may specialize in general-purpose computation, while others may focus on data movement or acceleration tasks. The memory controller can implement prefill operations based on work requests, such as filling the memory hierarchy with matrices such as weight matrices and activation matrices. This architectural flexibility can enable disclosed implementations to be tailored for specific workloads, promoting scalability and power efficiency while enabling localized memory access patterns that reduce latency and interconnect traffic.

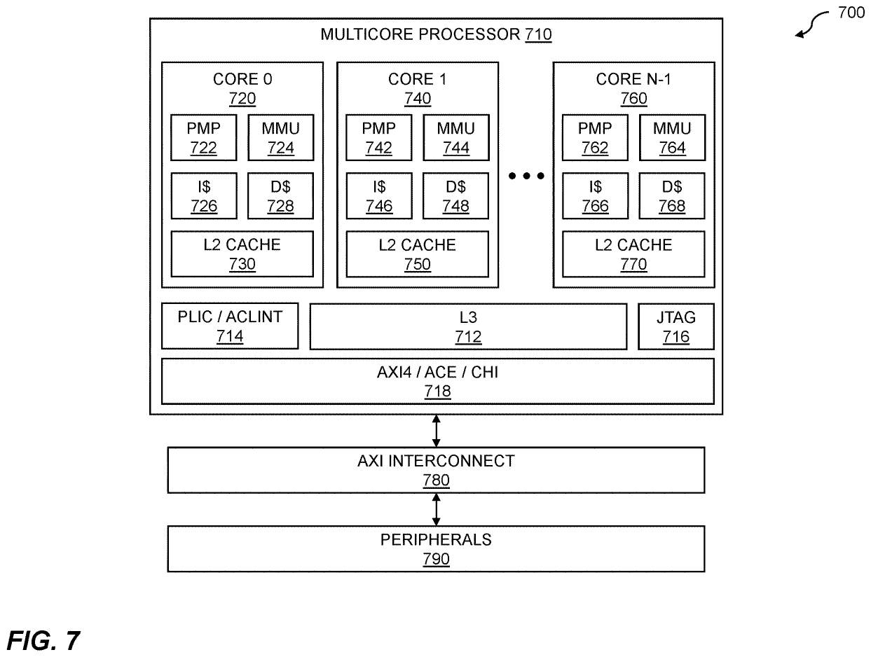

FIG. 7 is a block diagram of a multicore processor. The processor, such as a RISC-V® processor, an ARM® processor, or other suitable processor type, can include a variety of elements. The elements can include processor cores including multiprocessor cores, one or more caches including local caches and shared caches, memory protection and management units, local storage, and so on. The elements of the multicore processor can further include one or more of a private cache; a test interface such as a joint test action group (JTAG) test interface; one or more interfaces to a network such as a network-on-chip, shared memory, and peripherals; and the like.

In the block diagram 700, the multicore processor 710 can comprise two or more processors, where the two or more processors can include homogeneous processors, heterogeneous processors, etc. In the block diagram 700, the multicore processor can include N processor cores such as core 0 720, core 1 740, core N−1 760, and so on. Each processor can comprise one or more elements. In one or more implementations, each core, including cores 0 through core N−1, can include a physical memory protection (PMP) element, such as PMP 722 for core 0; PMP 742 for core 1, and PMP 762 for core N−1. In a processor architecture such as the RISC-V® architecture, a PMP can enable processor firmware to specify one or more regions of physical memory such as cache memory of the shared memory, and to control permissions to access the regions of physical memory. The cores can include a memory management unit (MMU) such as MMU 724 for core 0, MMU 744 for core 1, and MMU 764 for core N−1. The memory management units can translate virtual addresses used by software running on the cores to physical memory addresses with caches, the shared memory system, etc.

The processor cores associated with the multicore processor 710 can include caches such as instruction caches and data caches. The caches, which can comprise level 1 (L1) caches, can include an amount of storage such as 16 KB, 32 KB, and so on. The caches can include an instruction cache I$ 726 and a data cache D$ 728 associated with core 0; an instruction cache I$ 746 and a data cache D$ 748 associated with core 1; and an instruction cache I$ 766 and a data cache D$ 768 associated with core N−1. In addition to the level 1 instruction and data caches, each core can include a level 2 (L2) cache. The level 2 caches can include L2 cache 730 associated with core 0; L2 cache 750 associated with core 1; and L2 cache 770 associated with core N−1. The cores associated with the multicore processor 710 can include further components or elements. The further elements can include a level 3 (L3) cache 712. The level 3 cache, which can be larger than the level 1 instruction and data caches, and the level 2 caches associated with each core, can be shared among all of the cores. The further elements can be shared among the cores. In one or more implementations, the further elements can include a platform level interrupt controller (PLIC) 714. The platform-level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an advanced core local interrupter (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 716. The JTAG can provide a boundary within the cores of the multicore processor. The JTAG can enable fault information to a high precision. The high-precision fault information can be critical to rapid fault detection and repair.

The multicore processor 710 can include one or more interface elements 718. The interface elements can support standard processor interfaces including an Advanced eXtensible Interface (AXI®) such as AXI4®, an ARM® Advanced eXtensible Interface (AXI™) Coherence Extensions (ACE®) interface, an Advanced Microcontroller Bus Architecture (AMBA®) Coherence Hub Interface (CHI®), etc. In the block diagram 700, the interface elements can be coupled to the interconnect. The interconnect can include a bus, a network, and so on. The interconnect can include an AXI® interconnect 780. In one or more implementations, the network can include network-on-chip functionality. The AXI® interconnect can be used to connect memory-mapped “master” or boss devices to one or more “slave” or worker devices. In the block diagram 700, the AXI interconnect can provide connectivity between the multicore processor 710 and one or more peripherals 790. The one or more peripherals can include storage devices, networking devices, and so on. The peripherals can enable communication using the AXI® interconnect by supporting standards such as AMBA® version 4, among other standards.

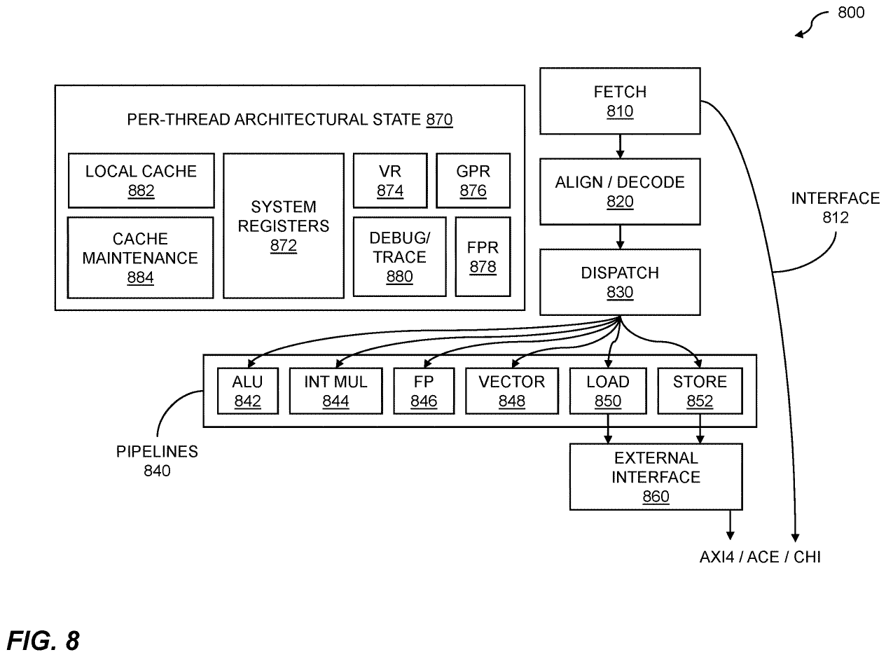

FIG. 8 is a block diagram of a pipeline. One or more pipelines associated with a processor architecture can be used to greatly enhance processing throughput. The processor architecture can be associated with one or more processor cores. The processing throughput can be increased because multiple operations can be executed in parallel. In one or more implementations, a processor core is accessed. The processor core is coupled to a memory hierarchy, and the processor core is configured to execute vector operations, scalar operations, and various micro-operations that implement architectural instructions.

The blocks within the block diagram can be configurable in order to provide varying processing levels. The varying processing levels can be based on processing speed, bit lengths, word lengths, numbers of micro-operations, and so on. The block diagram 800 can include a fetch block 810. The fetch block 810 can read a number of bytes from a cache such as an instruction cache (not shown). The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 812. The interface can include a standard interface such as one or more industry standard interfaces. The interfaces can include an Advanced eXtensible Interface (AXI®), an ARM® Advanced eXtensible Interface (AXI®) Coherence Extensions (ACE®) interface, an Advanced Microcontroller Bus Architecture (AMBA®) Coherence Hub Interface (CHI®), etc.

The block diagram 800 includes an align and decode block 820. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decoded packets. The decoded packets can be used in the pipeline to manage execution of operations. The block diagram 800 can include a dispatch block 830. The dispatch block can receive decoded instruction packets from the align and decode block. The decoded instruction packets can be used to control a pipeline 840, where the pipeline can include an in-order pipeline, an out-of-order (OoO) pipeline, etc. In one or more exemplary implementations, the processor core executes one or more instructions out of order. A pipeline can be associated with the one or more execution units. The pipelines associated with the execution units can include processor cores, arithmetic logic unit (ALU) pipelines 842, integer multiplier pipelines 844, floating-point unit (FPU) pipelines 846, vector unit (VU) pipelines 848, and so on. The dispatch unit can further dispatch instructions to pipelines that can include load pipelines 850, and store pipelines 852. The load pipelines and the store pipelines can access storage such as the common memory using an external interface 860. The external interface can be based on one or more interface standards such as the Advanced eXtensible Interface (AXI®). Following execution of the instructions, further instructions can update the register state. Other operations can be performed based on actions that can be associated with a particular architecture. The actions that can be performed can include executing instructions to update the system register state, trigger one or more exceptions, and so on.

In one or more exemplary implementations, the plurality of processors can be configured to support multi-threading. The system block diagram can include a per-thread architectural state block 870. The inclusion of the per-thread architectural state can be based on a configuration or architecture that can support multi-threading. In one or more exemplary implementations, thread selection logic can be included in the fetch and dispatch blocks discussed above. The per-thread architectural state can include system registers 872. The system registers can be associated with individual processors, a system comprising multiple processors, and so on. The system registers can include exception and interrupt components, counters, etc. The per-thread architectural state can include further registers such as vector registers (VRs) 874. The vector registers can be grouped in a vector register file and can be used for vector operations. In one or more exemplary implementations, the width of the vector register file is 512 bits. Additional registers such as general-purpose registers (GPRs) 876, and floating-point registers (FPRs) 878 can be included. These registers can be used for general purpose (e.g., integer) operations, and floating-point operations, respectively. The per-thread architectural state can include a debug and trace block 880. The debug and trace block can enable debug and trace operations to support code development, troubleshooting, and so on. In one or more exemplary implementations, an external debugger can communicate with a processor through a debugging interface such as a joint test action group (JTAG) interface. The per-thread architectural state can include a local cache state 882. The architectural state can include one or more states associated with a local cache such as a local cache coupled to a grouping of two or more processors. The local cache state can include clean or dirty, zeroed, flushed, invalid, and so on. The per-thread architectural state can include a cache maintenance state 884. The cache maintenance state can include maintenance needed, maintenance pending, and maintenance complete states, etc.

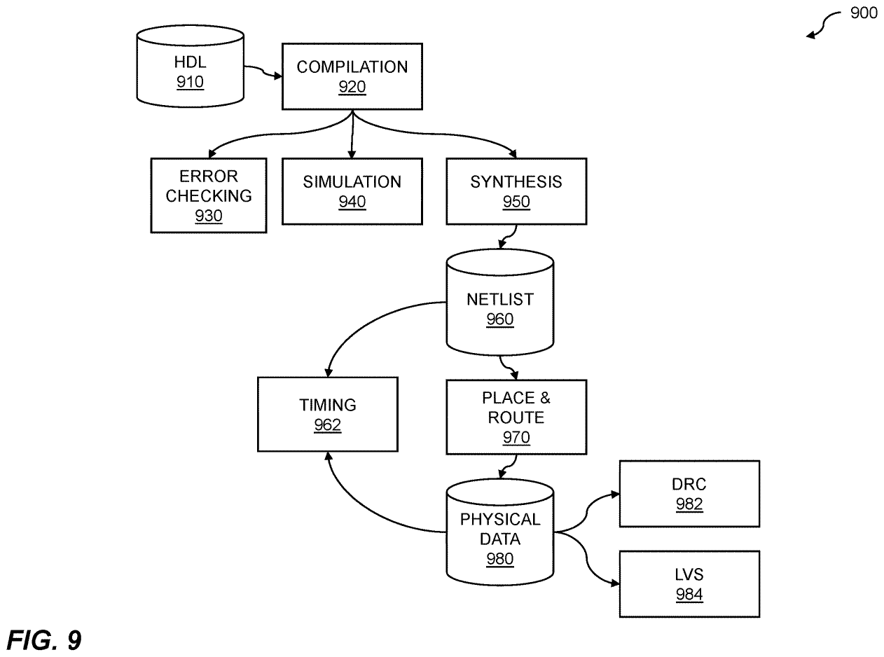

FIG. 9 is a design flow for semiconductor logic generation. Semiconductor logic generation can enable manufacture of a semiconductor that supports weight-stationary matrix multiply acceleration with a prefilled memory hierarchy. The design flow can be based on one or more design automation tools and can include instructions and/or functions for design, generation of semiconductor logic for, and implementation of integrated circuits that support non-flushing vector micro-operations with vector set (VSET). The design flow 900 can include instructions and/or functions for generation and/or manipulation of design data such as hardware description language (HDL) constructs for specifying the structure and operation of an integrated circuit. The design flow 900 can further perform operations to generate and manipulate register level transfer (RTL) abstractions. These abstractions can include parameterized inputs that enable specifying elements of a design such as a number of elements, sizes of various bit fields, sizes of caches, number of registers, enablement of certain features (such as architectural extensions), and so on. The parameterized inputs can be used as inputs to a logic synthesis process which can create semiconductor logic that implements the gate-level abstraction of the HDL. The gate level data can be further processed and used for fabrication of integrated circuit (IC) devices.

Modern integrated circuit designs are typically created using complex software design automation tools. The design flow 900 includes a hardware description language (HDL) 910 of a logic design. The HDL can enable a human to create and test a description of a logic function, logic block, system, etc. they want to design by describing the system using code. Any HDL can be used, including Verilog®, VHDL, SystemC, Chisel, and other languages. The code can describe the system at various levels of abstraction. The levels of abstraction can include a high level of abstraction that describes the behavior of the system, at a register transfer level (RTL), which describes the design based on the transfer of data between registers; at a gate level description, which names the particular circuits used and the interconnections between them; and so on. For example, a high level behavioral description may describe multiplication as C=A*B. An RTL level may describe loading data into register A, loading data into register B, performing a multiplication operation, and storing the product of A and B in register C. A circuit level description may name the particular circuits to use and the interconnections among them. At the RTL stage, disclosed implementations can capture both functional behavior and timing relationships. While the behavioral description can be the most user friendly, the RTL description can enable more control over how the design is implemented. Common text file formats, such as “.v”, “.vhd”, are typically used for the HDL source code in the semiconductor design flow.

The HDL source code can be compiled 920. The compilation can comprise one or more analysis, parsing, and/or elaboration steps. The compilation can result in an executable model of the HDL source code, which can be suitable for further steps of design automation. The executable model can be hierarchical. The compilation process can include error checking 930. The error checking can include syntactical checking; semantic checking; checking of references to other referenced libraries, designs, and models; etc. One or more implementations may include automated linting tools that detect undeclared signals, mismatched bit widths, or unused variables in HDL code.

One or more implementations may include simulation 940 of the HDL or RTL code prior to synthesis. Simulation environments can enable verification of design parameters such as functional correctness, timing behavior, and corner cases. By running testbenches against the HDL code, designers can confirm that arbitration logic operates as intended before committing to gate level synthesis. Simulation can also provide visibility into signal waveforms and processor request interactions, ensuring that arbitration criteria are correctly enforced. One or more implementations may also address conflicts that arise in visualization and reporting. For example, waveform viewers and schematic generators may use color coding to distinguish signals, buses, and states. Conflicts in color assignments or overlapping graphical elements can obscure analysis. Tools therefore include configurable color palettes and conflict resolution mechanisms to ensure clarity in simulation results and design documentation.

Synthesis 950 tools can be used to map the abstract operations captured by the HDL code into logic gates, flip-flops, cache structures, interconnect structures, etc. This process can enable automated generation of semiconductor logic that can be implemented in silicon, while preserving the intended arbitration and control functions originally specified. The synthesis can produce a gate level netlist 960 that represents the actual semiconductor logic structures such as described above. The netlist can be a technology-mapped netlist (e.g., mapped to a specific semiconductor fabrication technology). Synthesized netlists may be represented in formats such as EDIF, Liberty, and so on. In some implementations, checking can be performed to ensure that the logic generated by the synthesis tool is equivalent to the logic defined by the HDL source code. This can be accomplished by one or more testbenches, running one or more tests on larger blocks of logic and comparing those to the synthesized circuits, performing formal verification to prove logical equivalence between HDL and the netlist, and so on. Timing 962 can be performed on the netlist. The timing can generate an initial view including critical paths and/or paths that should be retimed with different synthesis directions. The timing information can be generated from established models of semiconductor devices, gates, etc. that have been selected by the synthesis tool. Estimates for wiring delays can also be included in the timing data.

The gate level netlist can be placed and routed 970 to produce physical data 980 which represents layout suitable for fabrication. Examples of place and route tools are Cadence® Innovus®, Synopsis IC complier®, versatile place and route (VPR), nextpnr, and others. Layout data is often exchanged in GDSII or OASIS formats. These standardized formats enable interoperability across tools and vendors, and support error checking during import/export. Timing 962 can again be run on the placed and routed design to ensure that the design meets cycle time requirements, taking into account more accurate wire lengths, parasitics, clock domains, and so on. Design rule checks (DRCs) 982 and layout versus schematic (LVS) 984 checks can confirm that the generated semiconductor logic adheres to fabrication constraints and matches the intended design. This tool-based flow demonstrates how software code can be transformed into concrete semiconductor logic structures, enabling support for claims directed to logic generation.

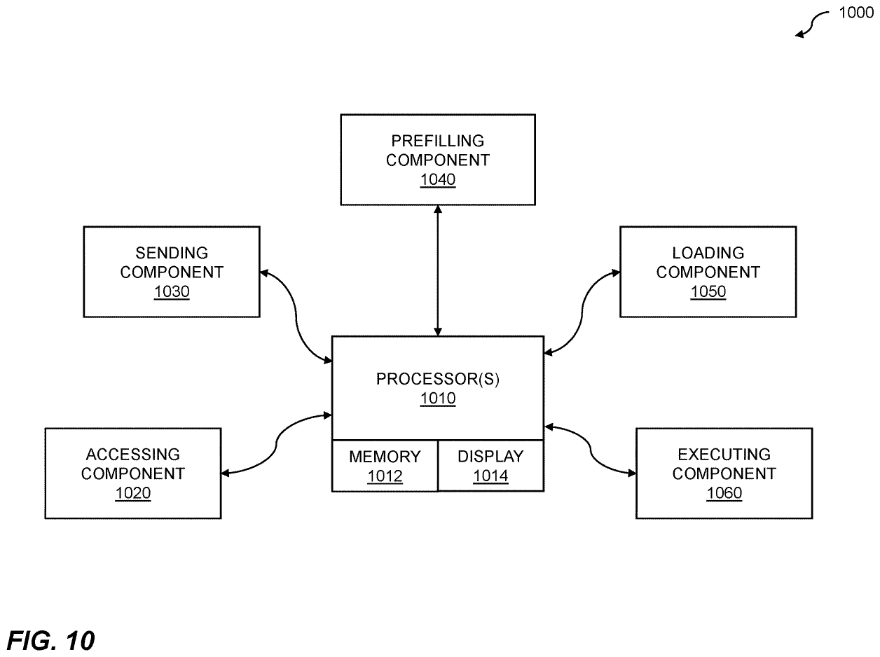

FIG. 10 is a system diagram for weight-stationary matrix multiply acceleration with a prefilled memory hierarchy. The system 1000 can include instructions and/or functions for design, generation of semiconductor logic for, and implementation of integrated circuits that support weight-stationary matrix multiply acceleration with a prefilled memory hierarchy. The system 1000 can include instructions and/or functions for generation and/or manipulation of design data such as hardware description language (HDL) constructs for specifying the structure and operation of an integrated circuit. The system 1000 can further perform operations to generate and manipulate Register Level Transfer (RTL) abstractions. These abstractions can include parameterized inputs that enable specifying elements of a design such as a number of elements, sizes of various bit fields, and so on. The parameterized inputs can be input to a logic synthesis tool which in turn creates the semiconductor logic that includes the gate-level abstraction of the design that is used for fabrication of integrated circuit (IC) devices.

The system can include one or more of processors, memories, cache memories, displays, and so on. The system 1000 can include one or more processors 1010. The processors can comprise processor cores. The processors can include standalone processors, processors within integrated circuits or chips, processor cores in FPGAs or ASICs, and so on. The one or more processors 1010 are coupled to a memory 1012, which stores instructions. The memory can include one or more of local memory, cache memory, system memory, etc. The system 1000 can further include a display 1014 coupled to the one or more processors 1010. The display 1014 can be used for displaying data, instructions, operations, micro-operations, operations using branch prediction with next program counter caches, and the like. The operations can include instructions and functions for implementation of integrated circuits, including processor cores. In exemplary implementations, the processor cores can include RISC-V® processor cores. A system comprising the one or more processors 1010, when executing the instructions which are stored in the memory 1012, is configured to enable weight-stationary matrix multiply acceleration with a prefilled memory hierarchy.

The system 1000 can include an accessing component 1020. The accessing component 1020 can include functions and instructions for accessing a matrix multiply accelerator (MMA), wherein the MMA includes a weight-stationary systolic array, wherein the MMA is coupled to a memory hierarchy, and wherein the memory hierarchy is coupled to a processor core. The processor core can include an ARM core, a MIPS core, and/or other suitable core type. In one or more exemplary implementations, the processor core can include a RISC-V architecture. The processor core can be configured to execute instructions and/or micro-operations, including matrix multiplication operations.

The system 1000 can include a sending component 1030. The sending component 1030 can include functions and instructions for sending, by the processor core, a first work request to the MMA, wherein the sending includes alerting the memory hierarchy of the first work request, wherein the first work request is based on execution of a machine learning model. In disclosed implementations, a memory hierarchy between the processor and the matrix multiply accelerator (MMA) can enable high-performance matrix multiplication by optimizing data locality and bandwidth utilization. By staging data, such as weight and activation matrices, in levels of memory (e.g., L1, L2, and/or shared cache), disclosed implementations can reduce the latency of data access for the MMA while also offloading traffic from main memory. This layered approach can enable the processor to efficiently prefetch and prepare data for upcoming matrix operations, ensuring a steady flow of inputs to the MMA and minimizing computation stalls.

The system 1000 can include a prefilling component 1040. The prefilling component 1040 can include functions and instructions for prefilling the memory hierarchy with a weight matrix and an activation matrix, wherein the weight matrix and the activation matrix are associated with the first work request that was sent. The prefilling can reduce latency by eliminating stalls due to waiting for memory accesses. In a normal process, the MMA can request data from the memory hierarchy. If not available, the MMA must wait until data is fetched from a shared cache on a mesh network, main memory, disk, etc. This can cause the MMA to stall for many cycles. Prefilling can hide that latency while other operations continue in the MMA.

The system 1000 can include a loading component 1050. The loading component 1050 can include functions and instructions for loading, by the MMA, the weight matrix and the activation matrix from the memory hierarchy into the MMA, wherein the loading is based on the prefilling. When the data is prefilled, the memory hierarchy can notify the MMA that data is ready. Embodiments include notifying the MMA, by the memory hierarchy, when the prefilling is complete. Then, when the MMA initiates computation, the MMA can quickly load the prefilled data from the cache, avoiding delays associated with fetching from slower memory tiers. This approach can support sustained high-throughput operations and help maintain a smooth, uninterrupted computational pipeline.

The system 1000 can include an executing component 1060. The executing component 1060 can include functions and instructions for executing the first work request, by the MMA, wherein the first work request comprises multiplying the weight matrix by the activation matrix, and wherein the multiplying results in an answer matrix. In disclosed implementations, a request-based approach to controlling MMA operations allows the processor to offload matrix computations efficiently while retaining system responsiveness. The processor submits a work request specifying matrix data, and the MMA performs the multiplication independently. Once the answer matrix is computed and stored in the memory hierarchy (e.g., L2 cache), the MMA signals the processor, such as using an interrupt, flag, semaphore, and/or similar mechanism, that the result is ready. This asynchronous communication frees the processor to execute other tasks in parallel, improving overall throughput and resource utilization in AI and other high-performance computing workloads.

The system 1000 can include a computer program product embodied in a non-transitory computer readable medium for matrix processing, the computer program product comprising code which causes one or more processors to generate semiconductor logic for: accessing a matrix multiply accelerator (MMA), wherein the MMA includes a weight-stationary systolic array, wherein the MMA is coupled to a memory hierarchy, and wherein the memory hierarchy is coupled to a processor core; sending, by the processor core, a first work request to the MMA, wherein the sending includes alerting the memory hierarchy of the first work request, wherein the first work request is based on execution of a machine learning model; prefilling the memory hierarchy with a weight matrix and an activation matrix, wherein the weight matrix and the activation matrix are associated with the first work request that was sent; loading, by the MMA, the weight matrix and the activation matrix from the memory hierarchy into the MMA, wherein the loading is based on the prefilling; and executing the first work request, by the MMA, wherein the first work request comprises multiplying the weight matrix by the activation matrix, and wherein the multiplying results in an answer matrix.

The system 1000 can include a computer system for matrix processing comprising: a memory which stores instructions; one or more processors attached to the memory, wherein the one or more processors, when executing the instructions which are stored, are configured to: access a matrix multiply accelerator (MMA), wherein the MMA includes a weight-stationary systolic array, wherein the MMA is coupled to a memory hierarchy, and wherein the memory hierarchy is coupled to a processor core; send, by the processor core, a first work request to the MMA, wherein the sending includes alerting the memory hierarchy of the first work request, wherein the first work request is based on execution of a machine learning model; prefill the memory hierarchy with a weight matrix and an activation matrix, wherein the weight matrix and the activation matrix are associated with the first work request that was sent; load, by the MMA, the weight matrix and the activation matrix from the memory hierarchy into the MMA, wherein the loading is based on the prefilling; and execute the first work request, by the MMA, wherein the first work request comprises multiplying the weight matrix by the activation matrix, and wherein the multiplying results in an answer matrix.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript®, ActionScript®, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for matrix processing comprising:
accessing a matrix multiply accelerator (MMA), wherein the MMA includes a weight-stationary systolic array, wherein the MMA is coupled to a memory hierarchy, and wherein the memory hierarchy is coupled to a processor core;
sending, by the processor core, a first work request to the MMA, wherein the sending includes alerting the memory hierarchy of the first work request, wherein the first work request is based on execution of a machine learning model;
prefilling the memory hierarchy with a weight matrix and an activation matrix, wherein the weight matrix and the activation matrix are associated with the first work request that was sent;
loading, by the MMA, the weight matrix and the activation matrix from the memory hierarchy into the MMA, wherein the loading is based on the prefilling; and
executing the first work request, by the MMA, wherein the first work request comprises multiplying the weight matrix by the activation matrix, and wherein the multiplying results in an answer matrix.

2. The method of claim 1 wherein the prefilling is accomplished by the processor core.

3. The method of claim 2 wherein the prefilling comprises prefetching the weight matrix and the activation matrix.

4. The method of claim 3 wherein the memory hierarchy includes an L2 cache, wherein the L2 cache includes a dedicated port, wherein the prefetching uses the dedicated port.

5. The method of claim 3 wherein the sending includes a second work request.

6. The method of claim 5 further comprising pipelining the first work request and the second work request.

7. The method of claim 6 wherein the prefetching includes a second activation matrix, wherein the second activation matrix is specified by the second work request.

8. The method of claim 7 wherein the prefetching of the second activation matrix occurs during the executing of the first work request.

9. The method of claim 7 wherein the weight matrix remains loaded in the weight-stationary systolic array.

10. The method of claim 9 wherein the multiplying includes further multiplying the weight matrix and the second activation matrix, wherein the further multiplying results in a second answer matrix.

11. The method of claim 1 wherein the first work request specifies a memory location of the weight matrix and a location of the activation matrix.

12. The method of claim 1 further comprising notifying the MMA, by the memory hierarchy, when the prefilling is complete.

13. The method of claim 12 further comprising stalling, by the MMA, wherein the stalling is based on the notifying.

14. The method of claim 1 wherein the multiplying is based on a plurality of partial products.

15. The method of claim 14 wherein one or more row tails within the MMA accumulate the plurality of partial products.

16. The method of claim 1 further comprising storing, by the MMA, the answer matrix in the memory hierarchy.

17. The method of claim 16 further comprising signaling, to the processor core, by the MMA, when the storing is complete.

18. The method of claim 17 further comprising obtaining, by the processor core, from the memory hierarchy, the answer matrix.

19. The method of claim 1 wherein the MMA is included within a system-on-chip (SoC), wherein the SoC includes a plurality of cache coherency blocks (CCBs), wherein each CCB within the plurality of CCBs is located on a unique tile within an M×N mesh of tiles.

20. The method of claim 19 wherein at least one of the tiles within the M×N mesh of tiles includes one or more processor cores and at least one MMA.

21. The method of claim 19 wherein at least one tile within the M×N mesh of tiles includes a memory controller.

22. A computer program product embodied in a non-transitory computer readable medium for matrix processing, the computer program product comprising code which causes one or more processors to generate semiconductor logic for:
accessing a matrix multiply accelerator (MMA), wherein the MMA includes a weight-stationary systolic array, wherein the MMA is coupled to a memory hierarchy, and wherein the memory hierarchy is coupled to a processor core;
sending, by the processor core, a first work request to the MMA, wherein the sending includes alerting the memory hierarchy of the first work request, wherein the first work request is based on execution of a machine learning model;
prefilling the memory hierarchy with a weight matrix and an activation matrix, wherein the weight matrix and the activation matrix are associated with the first work request that was sent;
loading, by the MMA, the weight matrix and the activation matrix from the memory hierarchy into the MMA, wherein the loading is based on the prefilling; and
executing the first work request, by the MMA, wherein the first work request comprises multiplying the weight matrix by the activation matrix, and wherein the multiplying results in an answer matrix.

23. A computer system for matrix processing comprising:
a memory which stores instructions;
one or more processors coupled to the memory, wherein the one or more processors, when executing the instructions which are stored, are configured to:
access a matrix multiply accelerator (MMA), wherein the MMA includes a weight-stationary systolic array, wherein the MMA is coupled to a memory hierarchy, and wherein the memory hierarchy is coupled to a processor core;
send, by the processor core, a first work request to the MMA, wherein the sending includes alerting the memory hierarchy of the first work request, wherein the first work request is based on execution of a machine learning model;
prefill the memory hierarchy with a weight matrix and an activation matrix, wherein the weight matrix and the activation matrix are associated with the first work request that was sent;
load, by the MMA, the weight matrix and the activation matrix from the memory hierarchy into the MMA, wherein the loading is based on the prefilling; and
execute the first work request, by the MMA, wherein the first work request comprises multiplying the weight matrix by the activation matrix, and wherein the multiplying results in an answer matrix.
